(19) United States
(12) Patent Application Publication
(10) Pub. No.: US 2024/0296576 A1
(43) Pub. Date: Sep. 5, 2024

(54) DEPTH ESTIMATION FOR THREE-DIMENSIONAL (3D) RECONSTRUCTION OF SCENES WITH REFLECTIVE SURFACES

(71) Applicant: QUALCOMM Incorporated, San Diego, CA (US)

(72) Inventors: Mohsen Ghafoorian, Diemen (NL); Georgi Dikov, Amsterdam (NL); Xuepeng Shi, London (GB); Jihong Ju, Amsterdam (NL); Gerhard Reitmayr, Del Mar, CA (US)

(21) Appl. No.: 18/447,709

(22) Filed: Aug. 10, 2023

Related U.S. Application Data
(60) Provisional application No. 63/488,086, filed on Mar. 2, 2023.

(51) Int. Cl. G06T 7/55

(52) U.S. Cl. CPC G06T 7/55; G06T 2207/20081; G06T 2207/20224

(57) ABSTRACT

This disclosure provides systems, methods, and devices for image signal processing that support artificial intelligence (AI)-based processing of image data for reconstructing 3D worlds. In a first aspect, a method of image processing includes receiving a plurality of image frames representing a scene; determining a first depth prediction for the scene based on the plurality of image frames; determining a reconstructed mesh from the plurality of image frames; determining a second depth prediction for the scene based on the reconstructed mesh; and determining a third depth prediction based on the first depth prediction and the second depth prediction. Other aspects and features are also claimed and described.

### PRIORITY CLAIM

The present application claims priority to and the benefit of U.S. Provisional Application 63/488,086, filed Mar. 2, 2023, the entirety of which is herein incorporated by reference.

### TECHNICAL FIELD

Aspects of the present disclosure relate generally to image processing, and more particularly, to artificial intelligence-based image processing. Some features may enable and provide improved image processing, including improved 3D world reconstruction from image data by reducing artifacts from non-Lambertian surfaces in image data from which the scene is being reconstructed.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects of this disclosure provide techniques for improved 3D reconstruction of a scene from 2D image data based on multiple depth predictions for the 3D reconstruction to remove artifacts caused by non-Lambertian surfaces. For instance, predicted depths from the 2D image data suffer from reflection and other potential artifacts, but provide high frequency details for the scene. Reprojected depths (e.g., a depth prediction) from a 3D reconstruction do not suffer from as many reflection artifacts, but lack high frequency details for the scene. The provided techniques involve fusing the predicted depth and the reprojected depth together to determine a fused depth, which is an improved depth determination for the scene represented in the 2D image data and represented in the 3D reconstruction as compared to the predicted depth and the reprojected depth. In this way, the resulting scene information with the fused depth values includes less degradation from reflective surface artifacts and also provides higher-level details of the scene. The fused depth may be determined with a mask that fuses the predicted and reprojected depth values based on one or more criteria. In various embodiments, a depth estimation model (e.g., the depth estimation model that predicted the depth from the 2D image data) may be retrained with fused depths as pseudo-labels to improve the fine-tuning of the depth estimation model.

In one aspect of the disclosure, a method for image processing includes receiving a plurality of image frames representing a scene; determining a first depth prediction for the scene based on the plurality of image frames; determining a reconstructed mesh from the plurality of image frames; determining a second depth prediction for the scene based on the reconstructed mesh; and determining a third depth prediction based on the first depth prediction and the second depth prediction.

In an additional aspect of the disclosure, an apparatus includes at least one processor and a memory coupled to the at least one processor. The at least one processor is configured to perform operations including receiving a plurality of image frames representing a scene at least one time; determining a first depth prediction for the scene based on the plurality of image frames; determining a reconstructed mesh from the plurality of image frames; determining a second depth prediction for the scene based on the reconstructed mesh; and determining a third depth prediction based on the first depth prediction and the second depth prediction.

In an additional aspect of the disclosure, an apparatus includes means for receiving a plurality of image frames representing a scene; means for determining a first depth prediction for the scene based on the plurality of image frames; means for determining a reconstructed mesh from the plurality of image frames; means for determining a second depth prediction for the scene based on the reconstructed mesh; and means for determining a third depth prediction based on the first depth prediction and the second depth prediction.

In an additional aspect of the disclosure, a non-transitory computer-readable medium stores instructions that, when executed by a processor, cause the processor to perform operations. The operations include receiving a plurality of image frames representing a scene at least one time; determining a first depth prediction for the scene based on the plurality of image frames; determining a reconstructed mesh from the plurality of image frames; determining a second depth prediction for the scene based on the reconstructed mesh; and determining a third depth prediction based on the first depth prediction and the second depth prediction.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.).

While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing artificial intelligence operations on image data according to one or more embodiments of the disclosure.

FIG. 2 is an example of a scene showing an error resulting from conventional processing of a non-Lambertian surface.

FIG. 3 is a block diagram illustrating a technique for predicting depths in a scene during 3D reconstruction according to one or more embodiments of this disclosure.

FIG. 4 shows a flow chart of an example method for processing image data to obtain improved depth value for a 3D reconstruction of a scene according to some embodiments of the disclosure.

FIG. 5 is pseudo-code for executing a 3D reconstruction process with improved depth representations according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Artificial intelligence (AI)-based processing of image data may be used to reconstruct a three-dimensional (3D) environment represented by image frames captured of a scene. The AI processing may include self-supervised processing to determine depths of objects in a scene from a collection of image frames. However, the depth estimation model for non-Lambertian surfaces (e.g., surfaces that can reflect light sources in a non-diffuse manner) has room for improvement. For example, a whiteboard is an example of a surface that, depending on which angle is used to view the whiteboard, the viewer receives a different kind of reflection. Models that are trained with self-supervision are prone to these reflection artifacts, resulting in depth predictions for the surface that are farther away than the actual surface. 3D reconstructions using depth data containing these reflections have clouds of false positive geometry (e.g., wrong geometry behind the actual whiteboard), which is undesirable.

The present disclosure provides systems, apparatus, methods, and computer-readable media that support image processing, including techniques for improved 3D reconstruction of a scene from 2D image data based on multiple depth predictions for the 3D reconstruction to remove artifacts caused by non-Lambertian surfaces. For instance, predicted depths from the 2D image data suffer from reflection and other potential artifacts, but provide high frequency details for the scene. Reprojected depths (e.g., a depth prediction) from a 3D reconstruction do not suffer from as many reflection artifacts, but lack high frequency details for the scene. The provided techniques involve fusing the predicted depth and the reprojected depth together to determine a fused depth, which is an improved depth determination for the scene represented in the 2D image data and represented in the 3D reconstruction as compared to the predicted depth and the reprojected depth. In this way, the resulting scene information with the fused depth values is degraded less from reflective surface artifacts and also provides higher-level details of the scene. The fused depth may be determined with a mask that fuses the predicted and reprojected depth values based on one or more criteria. In various embodiments, a depth estimation model (e.g., the depth estimation model that predicted the depth from the 2D image data) may be retrained with fused depths as pseudo-labels to improve the fine-tuning of the depth estimation model.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame” and “corrected image frame” may refer to image frames that have been processed by any of the discussed techniques. Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU)) configured to perform the recited function through hardware, software, or a combination of hardware configured by software.

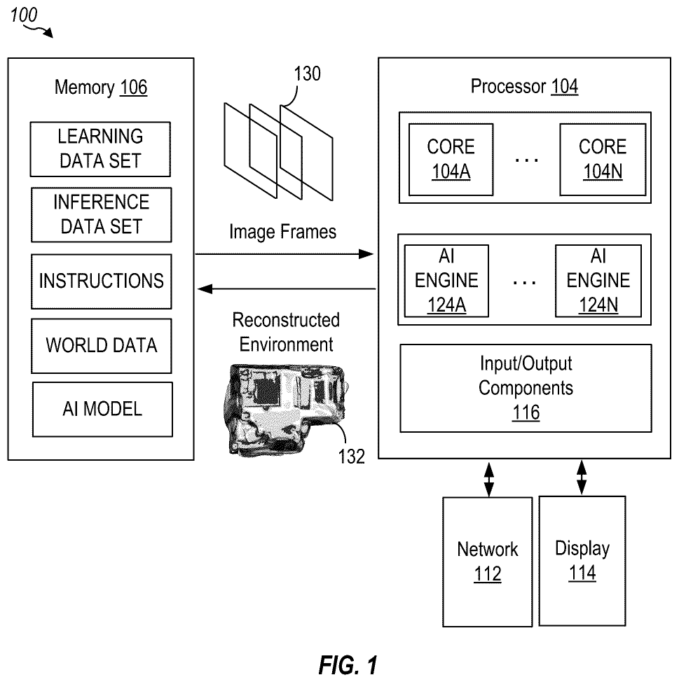

FIG. 1 shows an example configuration for processing image data, which may be embodied in an electronic device, such as a smartphone. For example, FIG. 1 shows a block diagram of an example device 100 for performing artificial intelligence operations on image data according to one or more embodiments of the disclosure. The device 100 may include a processor 104, which may be a central processing unit (CPU), image signal processors (ISPs), or other co-processor. The processor 104 may include computer vision processing (CVPs) capability, such as may be provided by AI engines 124A-N or other suitable circuitry for processing images captured by the image sensors. The processor 104 may retrieve image data (e.g., formatted as one or more image frames) from a memory 106 through a bus. The memory 106 may store instructions, image data, training data sets, inference data sets, and/or artificial intelligence (AI) models. The processor 104 may execute instructions on an inference data set using one or more AI models to generate world data, such as a reconstructed environment 132, for storage in memory 106 and/or other data resulting from the processing of the image data in the memory 106 through a bus. The processing circuitry may perform further processing, such as for encoding, storage, transmission, and/or other manipulation of output image frames. The processor 104 may be an image signal processor (ISP) when the processor 104 includes circuitry, such as an analog front end (AFE) for interfacing with cameras or other sensors for recording image data.

The device 100 may also include or be coupled to a display 114 through input/output (I/O) components 116. I/O components 116 may be used for interacting with a user, such as a touch screen interface and/or physical buttons. I/O components 116 may also include network interfaces for communicating with other devices on network 112, including a wide area network (WAN) adaptor, a local area network (LAN) adaptor, and/or a personal area network (PAN) adaptor. An example WAN adaptor is a 4G LTE or a 5G NR wireless network adaptor. An example LAN adaptor is an IEEE 802.11 WiFi wireless network adapter. An example PAN adaptor is a Bluetooth wireless network adaptor. Each of the adaptors may be coupled to an antenna, including multiple antennas configured for primary and diversity reception and/or configured for receiving specific frequency bands.

The device 100 may also include or be coupled to additional features or components that are not shown in FIG. 1. In one example, a wireless interface, which may include a number of transceivers and a baseband processor, may be coupled to or included in I/O components 116 for a wireless communication device. In a further example, an analog front end (AFE) to convert analog image frame data to digital image frame data may be coupled between image sensors and the processor 104.

Examples of image data include data captured by image sensors (e.g., photographs) and/or data captured by other sensors, such as Time of Flight (iToF), direct Time of Flight (dToF), light detection and ranging (Lidar), mmWave, radio detection and ranging (Radar), and/or hybrid depth sensors, such as structured light. In some embodiments image data information may be derived from other image data, such as with disparity between two image sensors (e.g., using depth-from-disparity or depth-from-stereo), phase detection auto-focus (PDAF) sensors, or the like.

The processor 104 may execute instructions from memory 106 and/or instructions stored in a separate memory coupled to or included in the processor 104. In addition, or in the alternative, the processor 104 may include specific hardware (such as one or more integrated circuits (ICs)) configured to perform one or more operations described in the present disclosure. In some embodiments, the memory 106 may include a non-transient or non-transitory computer readable medium storing computer-executable instructions to perform all or a portion of one or more operations described in this disclosure.

The processor 104 may include one or more general-purpose processor cores 104A capable of executing scripts or instructions of one or more software programs, such as instructions stored within the memory 106. For example, the processor 104 may include one or more application processors configured to execute a camera application (or other suitable application for recording images data) stored in the memory 106. In some embodiments, the processor 104 executes instructions to perform various operations described herein, including for determining improved 3D reconstructions of a scene. For example, an improved 3D model of a scene may be reconstructed with better depth determinations using techniques described herein.

In some embodiments, the processor 104 may include ICs or other hardware (e.g., an artificial intelligence (AI) engines 124A-N or other co-processor) to offload certain tasks from the cores 104A. The AI engines 124A-N may be used to offload tasks related to, for example, face detection and/or object recognition.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

In some embodiments, artificial intelligence (AI)-based processing of image data may be used to reconstruct a three-dimensional (3D) environment represented by image frames captured of a scene. The AI processing may include self-supervised processing to determine depths of objects in a scene from a collection of image frames. Self-supervision may work well with limited supervision data, which is difficult to obtain. However, the depth estimation model for non-Lambertian surfaces (e.g., surfaces that can reflect light sources in a non-diffuse manner) has room for improvement. For example, a whiteboard is an example of a surface that, depending on which angle is used to view the whiteboard, the viewer receives a different kind of reflection. Models that are trained with self-supervision are prone to these reflection artifacts, resulting in depth predictions for the surface that are farther away than the actual surface. 3D reconstructions using depth data containing these reflections have clouds of false positive geometry (e.g., wrong geometry behind the actual whiteboard), which is undesirable.

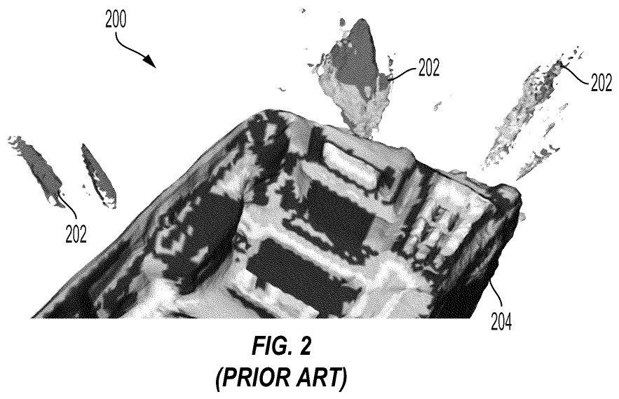

FIG. 2 is an example of a 3D reconstruction of a scene showing an error resulting from conventional processing of a non-Lambertian surface. A recreated scene 200 may include artifacts 202 that appear far off from the main portion 204 of the scene resulting from incorrect depth determinations from one or more non-Lambertian surfaces. For example, the artifacts 202 may be due to reflections on a surface in the scene.

Shortcomings mentioned here are only representative and are included to highlight problems that the inventors have identified with respect to existing processing techniques and sought to improve upon. Aspects of devices described below may address some or all of the shortcomings as well as others known in the art. Aspects of the improved processing described herein may present other benefits than, and be used in other applications than, those described above.

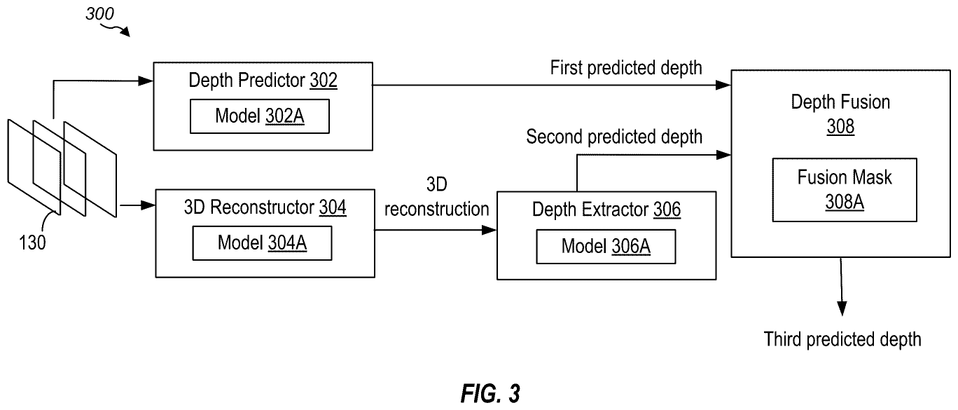

FIG. 3 is a block diagram illustrating a processing technique for predicting depths in a scene during 3D reconstruction, according to one or more embodiments of this disclosure. Predicted depths from 2D image data suffer from reflection and other potential artifacts, but provide high frequency details for the scene. Conversely, reprojected depths from 3D reconstruction do not suffer from as many reflection artifacts, but lack high frequency details for the scene. The present techniques involve fusing the predicted depths and reprojected depths together with a mask that determines fused depth values based on one or more criteria. In this way, the fused depths provide the positive characteristics of both the predicted depths and reprojected depths, namely less degradation from artifacts and high frequency details.

In the example of FIG. 3, processing 300 may include a depth predictor 302 processing image frames 130 to determine a first depth prediction (e.g., predicted depth values from 2D image data). The first depth prediction includes one or more first depth values. In an example, the depth predictor 302 may execute artificial intelligence, such as depth estimation model 302A, on input image frames 130 to determine the first depth prediction. The model 302A may be implemented as one or more machine learning models, including supervised learning models, unsupervised learning models, other types of machine learning models, and/or other types of predictive models. For example, the model 302A may be implemented as one or more of a neural network (e.g., depth convolutional neural network (CNN)), a transformer model, a decision tree model, a support vector machine, a Bayesian network, a classifier model, a regression model, and the like.

Processing 300 further includes a 3D reconstructor 304 processing input image frames 130 to form a 3D reconstruction from the image frames 130. For example, the 3D reconstructor 304 may execute artificial intelligence, such as model 304A, to determine the 3D reconstruction. The model 304A may be implemented as one or more machine learning models, including supervised learning models, unsupervised learning models, other types of machine learning models, and/or other types of predictive models. For example, the model 304A may be implemented as one or more of a neural network (e.g., convolutional neural network (CNN)), a transformer model, a decision tree model, a support vector machine, a Bayesian network, a classifier model, a regression model, and the like.

Depth data may be extracted from the 3D reconstruction at depth extractor 306 to obtain a second depth prediction. The second depth prediction includes one or more second depth values (e.g., reprojected depth values from 3D reconstruction). In an example, the depth extractor 306 may execute artificial intelligence, such as model 306A, to determine the second depth prediction. The model 306A may be implemented as one or more machine learning models, including supervised learning models, unsupervised learning models, other types of machine learning models, and/or other types of predictive models. For example, the model 306A may be implemented as one or more of a neural network (e.g., depth convolutional neural network (CNN)), a transformer model, a decision tree model, a support vector machine, a Bayesian network, a classifier model, a regression model, and the like.

In some embodiments, one or more of models 302A, 304A, and 306A may be implemented as a layer in a suitable machine learning model, such as one or more of the other models 302A, 304A, and 306A, rather than as a separate machine learning model.

The first and second depth predictions may then be fused via depth fusion 308 during processing 300 to obtain a third depth prediction (e.g., fused depth values), which is an improved depth determination for the scene represented in the image frames 130 and represented in the 3D reconstruction. The third depth prediction includes one or more fused depth values. In an example, each of the first depth values and second depth values are fused to obtain the fused depth values of the third depth prediction. The resulting scene information with the fused depth values suffers less from reflective surface artifacts and also provides the higher-level details of the scene.

The third depth prediction is determined based on the first and second depth predictions. Stated differently, the fused depth values of the third depth prediction are determined based on the first and second depth values of the first and second depth predictions. In an example, the third depth prediction is determined according to a fusion mask 308A of depth fusion 308 that implements one or more criteria with respect to the first and second depth values. In various aspects, the fusion mask 308A may indicate a binary decision to choose either a first depth value or a second depth value as the fused depth value for the resulting scene information in certain instances.

In an example of such aspects, when the first depth value is much larger than the second depth value at a location, the fused depth value is picked from the 3D reconstruction (i.e. the second depth value) because a reflection is likely present at that location and the second depth value obtained from the 3D reconstruction is more accurate at the location of the reflection than the first depth value. To implement this example, in various aspects, the binary decision criteria of the fusion mask 308A may be based on a difference between the first depth value and the second depth value. For instance, the criteria may be that the difference between the first and second depth values meets (e.g., equal to or greater than) a threshold value (e.g., percent). An example threshold value for an indoor scene is the first depth value being 25% greater than the second depth value. The threshold value may be tuned based on various types of scenes. In other aspects, the binary decision may be based on multi-view consistency or multi-model uncertainty (variance) estimation. In this example, when the difference between the first and second depth values fails to meet (e.g., less than) the threshold value, the first depth value is selected because a reflection is likely not present at that location and the first depth value is more accurate at the location of the reflection than the second depth value. according to the at least one weighting value.

In other aspects, the criteria of fusion mask 308A may indicate at least one weighting value for combining the first depth value and the second depth value to obtain a fused depth value. For example, in such aspects, each of the first depth value and the second depth value can be multiplied by a respective weighting value (e.g., a value between 0 and 1) and the resulting values can be combined (e.g., added) to determine the fused depth value of the third depth prediction. In various aspects, the respective weighting values may be determined based on a magnitude of the difference between the first depth value and the second depth value.

One or more of the depth predictor 302, the 3D reconstructor 304, and the depth extractor 306 may be implemented by software executed as processing 300 by the processor 104.

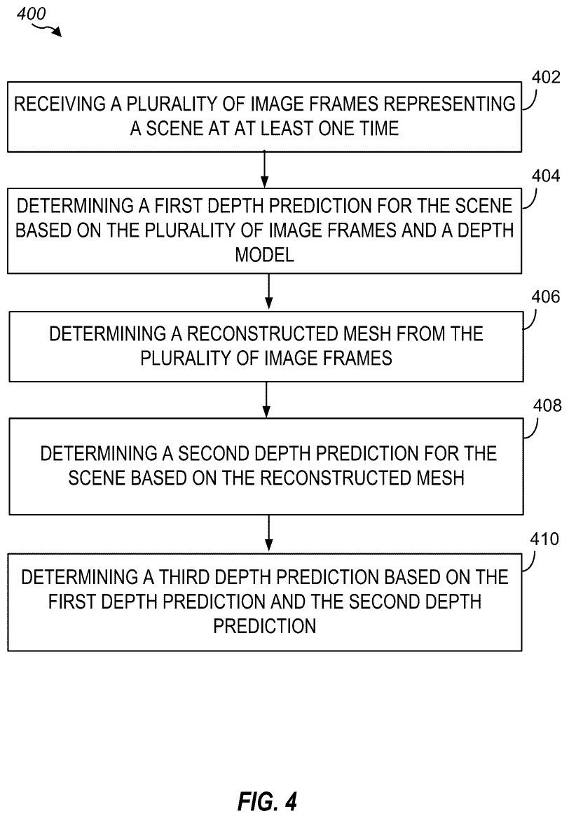

The exemplary image processing of FIG. 1 may be operated to obtain improved 3D reconstruction of a scene by performing aspects of the processing described in FIG. 3 according to the method shown in FIG. 4.

FIG. 4 shows a flow chart of an example method 400 for processing image data to obtain improved depth values for a 3D reconstruction of a scene according to some embodiments of the disclosure. At block 402, the method 400 includes receiving a plurality of image frames (e.g., image frames 130) representing a scene at least one time. In various aspects, the image frames 130 comprise image frames corresponding to a plurality of camera poses within the scene. At block 404, the method 400 includes determining a first depth prediction for the scene based on the image frames 130. The first depth prediction, which may include one or more first depth values, may be determined by a depth estimation model (e.g., model 302A). At block 406, the method 400 includes determining a reconstructed mesh (e.g., the 3D reconstruction formed by 3D reconstructor 304) from the image frames 130. The reconstructed mesh may be determined by a machine learning model (e.g., model 304A). At block 408, the method 400 includes determining a second depth prediction, which may include one or more second depth values, for the scene based on the 3D reconstruction. The second depth prediction may be determined by a machine learning model (e.g., model 306A).

At block 410, the method 400 includes determining a third (e.g., fused) depth prediction, which may include one or more third (e.g., fused) depth values, based on the first depth prediction and the second depth prediction. In at least some aspects, determining the third depth prediction is based on one or more criteria associated with first depth values of the first depth prediction with second depth values of the second depth prediction. For example, in some aspects, the one or more criteria includes, for each corresponding first depth value of the first depth values and second depth value of the second depth values for the scene, determining a difference between the first depth value and the second depth value. In such aspects, when the difference meets a threshold value, the second depth value is selected for the third depth prediction, and when the difference fails to meet the threshold value, the first depth value is selected for the third depth prediction. In various aspects, determining the third depth prediction includes determining a fusion mask indicating reflective surfaces in the scene, and determining the third depth prediction based on the fusion mask. In some examples of such aspects, the first depth prediction is based on a self-supervised model (e.g., model 302A) operating on the image frames 130. In other aspects, the criteria of fusion mask 308A may indicate at least one weighting value for combining the first depth value and the second depth value to obtain a fused depth value of the third depth prediction.

The data indicative of the third depth prediction may be output and stored in memory 106. The third depth prediction data may be read by the processor 104 and used to form a preview display on a display of the device 100 and/or processed to form a photograph for storage in memory 106, transmission to another device, or both.

In some embodiments, after the preprocessing of blocks 402-410, the method 400 may include reprojecting the reconstructed mesh into corresponding frames of the image frames 130 and blocking artifacts (e.g., from reflective surfaces) from being projected into the image frames 130. For example, the method 400 may include reprojecting the reconstructed mesh into the image frames 130 by using the third depth prediction to block artifacts in the first depth prediction from being projected into the image frames 130, and training a self-supervised depth model (e.g., model 302A) with the third depth prediction to mitigate reflective artifacts.

In some embodiments, after the preprocessing of blocks 402-410, the third predicted depth is used as training supervision to retrain (e.g., finetune) the depth estimation model (e.g., model 302A) that determined the first depth prediction. In such embodiments, the reconstructed environment 132 of FIG. 1 may be obtained by running inference on that retrained depth model directly without postprocessing. The retraining may be used to reduce computations at the inference time. For instance, in some embodiments, the fused frames can be extracted and re-integrated into the reconstructed mesh an additional time to create a scene mesh that is free of reflective surface artifacts. However, this processing imposes an extra cost at the inference time to perform one additional round of 3D reconstruction, depth projection, and fusion that may be eliminated in other embodiments. By retraining the depth estimation model with the fused depths as pseudo-labels to improve the fine-tuning of the depth estimation model, the depth estimation model may predict artifact-free predictions in the first execution and avoid the additional round of 3D reconstruction, depth projection, and fusion.

In some embodiments, the method 400 may include determining a second reconstructed mesh based on the third depth prediction.

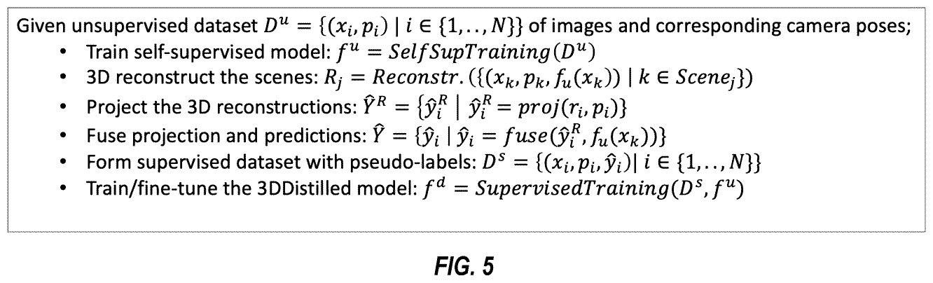

FIG. 5 is pseudo-code for executing a 3D reconstruction process with improved depth representations according to one or more embodiments of the disclosure. First, the process involves training a self-supervised model without any supervision. For example, given an unsupervised data set DU (e.g., image frames 130), the data set DU may be input to a self-supervised function and neural network f^{u} (e.g., block 402). Then, the process performs the 3D reconstruction on the 2D scenes to obtain reconstructed meshes (e.g., block 406). The depth predictions are determined from the same 2D scenes (e.g., block 404). Then, the 3D reconstruction is performed to get a reconstructed scene Rⱼ for scene j of input image xₖ. For a set of such scenes, a projection can be determined. First projected depth values may be determined as Ŷ^{R} because this is the labeled data (e.g., block 408). Then, the projected depths and the predicted depths are fused (e.g., block 410). Then, in various aspects, a new pseudo label Ŷ (e.g., third depth prediction) is determined and a supervised depth estimation model f^{d} is trained with this new data set D^{S} of pseudo labels. The supervised depth estimation model f^{d} may be used for future fused depth predictions.

In one or more aspects, techniques for supporting image processing may include additional aspects, such as any single aspect or any combination of aspects described below or in connection with one or more other processes or devices described elsewhere herein. Methods for image processing may be performed by an apparatus configured to receive image data to train a model and/or receive image data to generate inferences from a model.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of image processing may include one or more operations described herein with reference to the apparatus.

In a first aspect, the apparatus is configured to perform operations for image processing that may include receiving a plurality of image frames representing a scene; determining a first depth prediction for the scene based on the plurality of image frames; determining a reconstructed mesh from the plurality of image frames; determining a second depth prediction for the scene based on the reconstructed mesh; and determining a third depth prediction based on the first depth prediction and the second depth prediction.

In a second aspect, in combination with the first aspect, wherein the third depth prediction is determined based on one or more criteria with respect to first depth values of the first depth prediction and second depth values of the second depth prediction.

In a third aspect, in combination with one or more of the first aspect or the second aspect, the one or more criteria includes, for each corresponding first depth value of the first depth values and second depth value of the second depth values for the scene: determining a difference between the first depth value and the second depth value; when the difference meets a threshold value, selecting the second depth value for the third depth prediction; and when the difference fails to meet the threshold value, selecting the first depth value for the third depth prediction.

In a fourth aspect, in combination with one or more of the first aspect through the third aspect, determining the first depth prediction is based on a depth model, and the operations further include training the depth model with the third depth prediction.

In a fifth aspect, in combination with one or more of the first aspect through the fourth aspect, determining the third depth prediction includes determining a fusion mask indicating reflective surfaces in the scene, wherein determining the third depth prediction is based on the fusion mask.

In a sixth aspect, in combination with one or more of the first aspect through the fifth aspect, the plurality of image frames comprise image frames corresponding to a plurality of camera poses within the scene.

In a seventh aspect, in combination with one or more of the first aspect through the sixth aspect, the first depth prediction is based on a self-supervised model operating on the plurality of image frames.

In an eighth aspect, in combination with one or more of the first aspect through the seventh aspect, the apparatus is further configured to perform operations for determining a second reconstructed mesh based on the third depth prediction.

In a ninth aspect, in combination with one or more of the first aspect through the eighth aspect, the apparatus is further configured to perform operations for reprojecting the reconstructed mesh into the plurality of image frames by using the third depth prediction to block artifacts in the first depth prediction from being projected into the plurality of image frames; and training a self-supervised depth model with the third depth prediction to mitigate reflective artifacts.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4 and 5 may be combined with one or more blocks (or operations) described with reference to another of the figures. For example, one or more blocks (or operations) of FIG. 4 may be combined with one or more blocks (or operations) of FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method, comprising:
receiving a plurality of image frames representing a scene;
determining a first depth prediction for the scene based on the plurality of image frames;
determining a reconstructed mesh from the plurality of image frames;
determining a second depth prediction for the scene based on the reconstructed mesh; and
determining a third depth prediction based on the first depth prediction and the second depth prediction.

2. The method of claim 1, wherein the third depth prediction is determined based on one or more criteria with respect to first depth values of the first depth prediction and second depth values of the second depth prediction.

3. The method of claim 2, wherein the one or more criteria comprises:
for each corresponding first depth value of the first depth values and second depth value of the second depth values for the scene:
determining a difference between the first depth value and the second depth value;
when the difference meets a threshold value, selecting the second depth value for the third depth prediction; and
when the difference fails to meet the threshold value, selecting the first depth value for the third depth prediction.

4. The method of claim 2, wherein:
determining the first depth prediction is based on a depth model, and
the method further comprises:
training the depth model with the third depth prediction.

5. The method of claim 2, wherein determining the third depth prediction comprises:
determining a fusion mask indicating reflective surfaces in the scene,
wherein determining the third depth prediction is based on the fusion mask.

6. The method of claim 1, wherein the plurality of image frames comprise image frames corresponding to a plurality of camera poses within the scene.

7. The method of claim 6, wherein the first depth prediction is based on a self-supervised model operating on the plurality of image frames.

8. The method of claim 1, further comprising determining a second reconstructed mesh based on the third depth prediction.

9. The method of claim 1, further comprising:
reprojecting the reconstructed mesh into the plurality of image frames by using the third depth prediction to block artifacts in the first depth prediction from being projected into the plurality of image frames; and
training a self-supervised depth model with the third depth prediction to mitigate reflective artifacts.

10. An apparatus, comprising:
a memory storing processor-readable code; and
at least one processor coupled to the memory, the at least one processor configured to execute the processor-readable code to cause the at least one processor to perform operations including:
receiving a plurality of image frames representing a scene;
determining a first depth prediction for the scene based on the plurality of image frames;
determining a reconstructed mesh from the plurality of image frames;
determining a second depth prediction for the scene based on the reconstructed mesh; and
determining a third depth prediction based on the first depth prediction and the second depth prediction.

11. The apparatus of claim 10, wherein the third depth prediction is determined based on one or more criteria with respect to first depth values of the first depth prediction and second depth values of the second depth prediction.

12. The apparatus of claim 11, wherein the one or more criteria comprises:
for each corresponding first depth value of the first depth values and second depth value of the second depth values for the scene:
determining a difference between the first depth value and the second depth value;
when the difference meets a threshold value, selecting the second depth value for the third depth prediction; and
when the difference fails to meet the threshold value, selecting the first depth value for the third depth prediction.

13. The apparatus of claim 11, wherein:
determining the first depth prediction is based on a depth model, and
the operations further comprise:
training the depth model with the third depth prediction.

14. The apparatus of claim 11, wherein determining the third depth prediction comprises:
determining a fusion mask indicating reflective surfaces in the scene,
wherein determining the third depth prediction is based on the fusion mask.

15. The apparatus of claim 10, wherein the plurality of image frames comprise image frames corresponding to a plurality of camera poses within the scene.

16. The apparatus of claim 15, wherein the first depth prediction is based on a self-supervised model operating on the plurality of image frames.

17. The apparatus of claim 10, wherein the operations further comprise:
reprojecting the reconstructed mesh into the plurality of image frames by using the third depth prediction to block artifacts in the first depth prediction from being projected into the plurality of image frames; and
training a self-supervised depth model with the third depth prediction to mitigate reflective artifacts.

18. A non-transitory computer-readable medium storing instructions that, when executed by a processor, cause the processor to perform operations comprising:
receiving a plurality of image frames representing a scene;
determining a first depth prediction for the scene based on the plurality of image frames;
determining a reconstructed mesh from the plurality of image frames;
determining a second depth prediction for the scene based on the reconstructed mesh; and
determining a third depth prediction based on the first depth prediction and the second depth prediction.

19. The non-transitory computer-readable medium of claim 18, wherein the third depth prediction is determined based on one or more criteria with respect to first depth values of the first depth prediction and second depth values of the second depth prediction.

20. The non-transitory computer-readable medium of claim 18, wherein:
determining the first depth prediction is based on a depth model, and
the method further comprises:
training the depth model with the third depth prediction.
